(19) United States
(12) Patent Application Publication
(10) Pub. No.: US 2019/0166845 A1
(43) Pub. Date: Jun. 6, 2019

(54) METHODS OF TREATMENT AND PREVENTION OF WHITE SPOT IN MAIZE CROPS

(71) Applicant: UPL Limited, Haldia, West Bengal (IN)

(72) Inventors: Gilson Aparecido Hermenegildo De OLIVEIRA, Sao Paulo - SP (BR); Vicente Amadeo GONGORA, Sao Paulo - SP (BR); Florindo ORSI, Jr., Sao Paulo - SP (BR); Carlos Eduardo FABRI, Sao Paulo - SP (BR); Jaidev Rajnikant SHROFF, Dubai (AE); Vikram Rajnikant SHROFF, Dubai (AE)

(21) Appl. No.: 16/323,144

(22) PCT Filed: Aug. 2, 2017
(86) PCT No.: PCT/IB2017/054715

§ 371 Date: Feb. 4, 2019

(30) Foreign Application Priority Data
Aug. 4, 2016 (IN) 201631026703

(51) Int. Cl. A01N 47/14; A01N 43/54

(52) U.S. Cl. CPC A01N 47/14; A01N 43/54

(57) ABSTRACT

The present invention relates to a method of treating Phaeosphaeria leaf spot (PLS) or White spot. The method comprises treating the host crop with a combination of a dithiocarbamate and a Qo inhibitor fungicide and optionally a third fungicide selected from a contact or systemic fungicide.

### TECHNICAL FIELD

The present invention relates to treatment of specific diseases in maize crops. More specifically, the present invention relates to a method of treating Phaeosphaeria leaf spot (PLS) or White spot in maize (WSM).

### BACKGROUND

Phaeosphaeria leaf spot (PLS) or White spot in maize (WSM) is a major disease in maize that causes leaf lesions that initially appear as small, pale green or chlorotic spots scattered over the leaf surface. As lesions mature they become bleached and dried with dark brown margins. If untreated, the disease is widespread and can spread to other plants that may be susceptible. White spot in maize is widely distributed in South and Central America, Asia, and Africa and is considered a potential threat to maize production in regions where high humidity and low night-time temperatures are prevalent during the growing season. In Brazil, yield loss was as high as 60% if the disease is not controlled in time.

The additional host crops serve as a reservoir for spores which can settle over the winter on the host crops and then spread in warmer weather. Early detection and treatment of white spot is very essential to prevent the spread of disease and the loss of yield. Fungicides typically recommended for the treatment of this disease include Qo inhibitors (Quinone outside inhibitors), DM inhibitors (demethylation inhibitor) and combinations thereof, or contact fungicides such dithiocarbamates, benzimidazoles etc.

White spot was believed to be caused by multiple causative agents (R. M. Gon´alves et.al. Etiology of phaeosphaeria leaf spot disease of maize, Journal of Plant Pathology (2013), 95 (3), 559-569) these include a mixture of bacterial and fungal agents including Phaeosphaeria mydis and Pantoea ananatis, as well as other strains of fungi. The paper further discuss the various fungicides that may be able to control white spot in maize, including mancozeb and benomyl. Chemical control of foliar diseases in corn (Pinto, Revista Brasileira de Milho e Sorgo, v.3, n.1, p.134-138, 2004) discuss the use of various fungicides and antibiotics for the control of white spot in maize. The actives tested included tebuconazole, mancozeb, streptomycin sulphate, oxytetracycline, prothioconazole, azoxystrobin, mancozeb+tebuconazole etc.

Various combinations have been tried to control the disease. Most prior art mention effectiveness of mancozeb alone in controlling white spot in maize when applied before or in the initial phase of disease development (Pinto, N.F.J.A., 1999, Efficiency of doses and application intervals of fungicides on control of corn leaf spot, Ci, nc. e Agrotec. Lavras 23, 1006-1009). Other prior art teaches the use of triazoles, strobilurins and combinations of strobilurins with triazoles, or combinations of triazoles with dithiocarbamates (Effectiveness of association of fungicides and antibiotics to control white spots of corn and its effect on productivity, Fernando Cezar J uliatti, Biosci. J., Uberlndia, v. 30, n. 6, p. 1622-1630, November/December 2014) Combinations such as Azoxystrobin+Cyproconazole as well as E poxiconazole+Pyraclostrobin and Azoxystrobin alone when mixed with antibiotics and gave a strictly satisfactory control of white spot in maize. Recommended doses of Azoxystrobin+Cyproconazole were able to control the disease to some extent with some amount of yield improvement as compared to other combinations tested. The use of antibiotics to control the Pantoea ananatis infections, however, could escalate the risk of resistance in the strains. The present invention therefore, aims to mitigate this risk of resistance development.

The present invention therefore provides a method of controlling white spot in maize such that, the method can be applied at advanced or later stages of the disease, thereby providing resistance management and complete control of the disease. The present invention also provides an adequate and cost effective method to achieve complete control of white spot in maize, improving yields, while targeting resistance management and lower costs.

### SUMMARY OF THE INVENTION

In one aspect, the present invention provides a method of treating maize white spot infection in a host plant, wherein the treatment comprises treating the plant at the locus of the infection with a dithiocarbamate fungicide, and concurrently or subsequently to the dithiocarbamate fungicide, with at least another Qo inhibitor fungicide.

In another aspect, the present invention provides a combination for treating maize white spot infection in a host plant, wherein the combination comprises a dithiocarbamate fungicide, and at least another Qo inhibitor fungicide.

In another aspect, the present invention provides the use of a combination comprising a strobilurin fungicide and a dithiocarbamate fungicide for disease control in a host plant infected by Phaeosphaeria mydis and Pantoea ananatis.

### OBJECT OF THE INVENTION

It is an object of the present invention to provide a method to prevent and/or treat white spot infections in maize and/or infections by Phaeosphaeria mydis and Pantoea ananatis in a host plant.

It is another object of the present invention to provide a method of treating white spot in a host plant.

It is another object of the present invention to provide a method of treating white spot in a host plant such that the quantities of actives used in the treatment is greatly reduced.

### DETAILED DESCRIPTION

The initial symptoms of white spot in maize normally appear in the first basal leaf and may progress very rapidly to the upper leaves of infected plants. Disease symptoms are more severe after maize flowering. Normally, the disease is not observed at the seedling stage, and under severe attack symptoms may occur on the husk. Premature senescence of the leaves as well as reduction in grain size and weight may be observed during severe infections. It has surprisingly been found that the treatment of a host plant infected with Phaeosphaeria mydis and/or Pantoea ananatis when treated with a dithiocarbamate and at least a Qo inhibitor (Quinone outside inhibitors) fungicide resulted in greatly improved disease control and improved quality of the plant.

White spot in maize causes significant yield loss and damage to the crop. The disease is caused due a mixture of bacteria and fungi that become difficult to control in the later stages. It has surprisingly been found that the combination of a strobilurin fungicide and a dithiocarbamate effectively control white spot on maize, whilst showing significant improvements in yield.

Qo inhibitor (Quinone outside inhibitors) fungicides are known in the art and include oxazolidinediones, imidazolinones and strobilurine class of fungicides. However, the use of azoxystrobin or strobilurins in general have been observed to provide very low yields and less control of the disease in the later stages.

Dithiocarbamates are multi-site contact fungicides that have been used over the years for resistance management. However, there is no report of dithiocarbamate combined with a Qo inhibitor used for the synergistic treatment of white spot in maize. It has surprisingly been found that dithiocarbamates when combined with a Qo inhibitor (Quinone outside inhibitors) enhanced disease control of white spot in maize caused by Phaeosphaeria mydis and Pantoea ananatis infections.

Unexpectedly, it has also been found that dithiocarbamates in combination with Qo inhibitor fungicides also improved the quality of the plant by decreasing stress and improving nutrition levels, thereby increasing the yield.

Single active treatment regimen for white spot in maize has many drawbacks. Each active that has been used individually for the treatment of the disease, for example, azoxystrobin was one of the first of the Qo inhibitors to be used for the treatment of white spot in maize, the active gave good control. However, according to FRAC guidelines, azoxystrobin should be used more as a preventive fungicide. The risk of resistance developing to Qo inhibitors is very high when used alone continuously. Another drawback is that yield improvements were considerably less when single active treatments were used. Other combination treatment regimen used include combinations of DMI inhibitors and Qo inhibitors both are known to be used as preventive actives in combination, thereby increasing the chances of resistance development, even in maize strains that are known to be resistant to white spot in maize.

Qo inhibitor fungicides are known to be used for resistance management. The translaminar action of a strobilurin when combined with the actions of a mufti-site contact fungicide specifically a dithiocarbamate, has surprisingly been found to control and prevent white spot in maize synergistically.

The term contact fungicide as used herein for the dithiocarbamate fungicides denotes a fungicide that remains at the site where it is applied but does not travel within the plant. Typically, these fungicides do not show any post-infection activity.

The term “systemic fungicide” as used herein shall denote a fungicide that is absorbed into the plant tissue and possesses at least some amount of an after-infection activity. Preferably, the systemic fungicide of the present invention is capable of moving freely throughout the plant. However, the term “systemic fungicide” is intended herein to include the upwardly systemic fungicide as well as the locally systemic fungicide.

Dithiocarbamates, and mancozeb in particular, was one of the first contact fungicides to be used for the treatment of white spot in maize. Over the years many trials have been conducted on the use of mancozeb alone for the treatment of white spot in maize. However, it has now been surprisingly found that a combination or a sequential application of mancozeb with existing single actives Qo Inhibitors registered for white spot in maize greatly improves the treatment response, decreased disease severity quickly, and improved yield to a much larger extent.

Therefore, an aspect of the present invention provides a method of treating maize white spot infection in a host plant, wherein the treatment comprises treating the plant at the locus of the infection with a dithiocarbamate fungicide, and prior to, concurrently or subsequently to the dithiocarbamate fungicide, with at least a Qo inhibitor fungicide.

In an embodiment, the dithiocarbamate fungicide may be selected from but not limited to maneb, metiram, mancozeb, zineb, ziram, thiram, propineb and nabam.

In an embodiment, the preferred dithiocarbamate fungicide is mancozeb.

In an embodiment, the Qo inhibitors (Quinone outside inhibitors) may be selected from but are not limited to:
strobilurins selected from but not limited to azoxystrobin, coumoxystrobin, dimoxystrobin, enoxastrobin, flufenoxystrobin, fluoxastrobin, fenaminstrobin, kresoxim-methyl, metominostrobin, orysastrobin, pyraclostrobin, pyrametostrobin, picoxystrobin, pyribencarb, triclopyricarb, trifloxystrobin and mixtures thereof;
oxazolidinedione fungicide selected from famoxadone; and
imidazole fungicide selected from fenamidone or mixtures thereof.

In an embodiment, the preferred Qo inhibitor (Quinone outside inhibitors) may be selected from azoxystrobin, pyraclostrobin, picoxystrobin and trifloxystrobin or mixtures thereof.

In an embodiment, the preferred most Qo inhibitor (Quinone outside inhibitors) fungicide is azoxystrobin.

In an embodiment, the preferred dithiocarbamate is mancozeb and the Qo inhibitor (Quinone outside inhibitors) may be selected from but are not limited to azoxystrobin, coumoxystrobin, dimoxystrobin, enoxastrobin, flufenoxystrobin, fluoxastrobin, fenaminstrobin, kresoxim-methyl, metominostrobin, orysastrobin, pyraclostrobin, pyrametostrobin, picoxystrobin, pyribencarb, triclopyricarb, trifloxystrobin and mixtures thereof.

In an embodiment, the preferred dithiocarbamate is mancozeb and the preferred Qo inhibitor (Quinone outside inhibitors) may be selected from azoxystrobin, pyraclostrobin, picoxystrobin and trifloxystrobin or mixtures thereof.

In an embodiment, the preferred dithiocarbamate is mancozeb and the preferred Qo inhibitor is azoxystrobin.

Thus, in an embodiment, the present invention may provide a method of treating white spot in maize, comprising treating the plant at the locus of the infection with mancozeb, and prior to, concurrently or subsequently to mancozeb, with azoxystrobin.

In an embodiment, the dithiocarbamate is mancozeb and the Qo inhibitor is trifloxystrobin.

Thus, in an embodiment, the present invention may provide a method of treating white spot in maize, comprising treating the plant at the locus of the infection with mancozeb, and prior to, concurrently or subsequently to mancozeb, with trifloxystrobin.

In an embodiment, the dithiocarbamate is mancozeb and the Qo inhibitor is pyraclostrobin or picoxystrobin.

Thus, in an embodiment, the present invention may provide a method of treating white spot in maize, comprising treating the plant at the locus of the infection with mancozeb, and prior to, concurrently or subsequently to mancozeb, with pyraclostrobin or picoxystrobin.

In an aspect, the present invention may provide, a method of treating white spot in maize, comprising treating the plant at the locus of the infection with mancozeb, and prior to, concurrently or subsequently to mancozeb, with at least a Qo inhibitor and optionally a third fungicide selected from a contact or systemic fungicide.

In an embodiment, the systemic optional fungicide may be selected from but not limited to DM inhibitor (demethylation inhibitor), SDH inhibitor (succinate dehydrogenase inhibitors) or another multi-site contact fungicides.

In an embodiment, the DMI inhibitor may be selected from azaconazole, bitertanol, bromuconazole, cyproconazole, climbazole, clotrimazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, imazalil, metconazole, myclobutanil, oxpoconazole, pencoconazole, propiconazole, prothioconazole, prochloraz, prochloraz-manganese quinconazole, simeconazole, tebuconazole, tetraconazole, triadimefon, triadimenol, triticonazole, triflumizole, uniconazole, perfurazoate and uniconazole-P.

In an embodiment, the succinate dehydrogenase inhibitor is selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane and boscalid.

In an embodiment, the contact fungicide may be selected from copper fungicides, sulfur fungicides, phthalimide fungicides, chloronitrile fungicides, sulfamide fungicides, guanidine fungicides, triazines fungicides and quinone fungicides.

The application of the dithiocarbamate may be sequential or concurrent, such that the sequential application may be within up to 24 hours to 4 weeks of the application of at least one Qo inhibitor. In the case of concurrent application, the dithiocarbamate may be tank mixed with other actives or pre-formulated mixtures. As will be demonstrated in the examples, the addition of mancozeb to Qo inhibitor fungicide greatly increased the efficacy, thereby, improving the rate of disease control and improving the overall health of the plant.

The amount of dithiocarbamate to be sprayed may be in the range from 0.5 kg/ha to 25 kg/ha, preferred being 0.5 kg/ha to 10 kg/ha.

The amount of Qo inhibitors fungicide to be sprayed may be in the range from 1 kg/ha to 25 kg/ha, preferred being 0.5 kg/ha to 10 kg/ha.

In an embodiment, if the dithiocarbamate is tank mixed with the commercially available compositions containing Qo inhibitor, suggested dosage of those may be used may be according to the recommended dosage.

The method of treatment of the present invention may be carried out as tank mix sprays, or may be formulated as a kit of parts containing various components that may be mixed prior to spraying. The actives may be pre-formulated and may be in the form of solutions, emulsions, wettable powders, water-based and oil-based suspensions, water-based and oil-based suspension concentrates, powders, dusting products, pastes, soluble powders, granules, dispersible granules, soluble granules, granules for broadcasting, suspension-emulsion concentrates, natural materials impregnated with active compound, synthetic materials impregnated with active compound, fertilizers and ultra-fine encapsulations in polymeric compounds, capsule suspensions etc. Preferably, the actives may be pre-formulated into water dispersible granules.

Adjuvants and ancillary ingredients may be used to formulate such pre formulated compositions and may employ wetters, adhesives, dispersants or surfactants and, if appropriate solvent or oil and other agriculturally acceptable additives.

In an embodiment, the adjuvant may be selected from at least one dispersing agent, at least one wetting agent, at least one antifoam, at least one pH modifier, at least one surfactant and combinations thereof. The composition content of these adjuvants is not particularly limiting and may be determined by a skilled technician in the art according to the conventional protocols.

In one embodiment, the dispersing agent may be an ionic and nonionic dispersing agents such as salts of polystyrene sulphonic acids, salts of polyvinylsulphonic acids, salts of naphthalenesulphonic acid/formaldehyde condensates, salts of condensates of naphthalenesulphonic acid, phenolsulphonic acid and formaldehyde, and salts of lignosulphonic acid, polyethylene oxide/polypropylene oxide block copolymers, polyethylene glycol ethers of linear alcohols, reaction products of fatty acids with ethylene oxide and/or propylene oxide, furthermore polyvinyl alcohol, polyvinylpyrrolidone, copolymers of polyvinyl alcohol and polyvinylpyrrolidone and copolymers of (meth)acrylic acid and (meth)acrylic esters, furthermore alkyl ethoxylates and alkylarylethoxylates or a combination thereof.

In an embodiment, the wetting agent may be selected from soaps; salts of aliphatic monoesters of sulphuric acid including but not limited to sodium lauryl sulphate; sulfoalkylamides and salts thereof including but not limited to N-methyl-N-oleoyltaurate Na salt; alkylarylsulfonates including but not limited to alkylbenzenesulfonates; alkylnaphthalenesulfonates and salts thereof and salts of ligninsulfonic acid or a combination thereof.

In an embodiment, antifoaming agents may be selected from silicone oil and magnesium stearate or a suitable combination thereof.

In an embodiment, at least one pH modifier selected from organic and inorganic components that are usually employed in agrochemical compositions to modify the pH. In an embodiment, the pH modifier may be selected from potassium carbonate, potassium hydroxide, sodium hydroxide and sodium dihydrogen phosphate. However, the choice of a pH modifier is not particularly limiting.

In an embodiment, surfactants may be selected from salts of polystyrenesulphonic acids; salts of polyvinylsulphonic acids; salts of naphthalenesulphonic acid/formaldehyde condensates; salts of condensates of naphthalenesulphonic acid, phenolsulphonic acid and formaldehyde; salts of lignosulphonic acid; polyethylene oxide/polypropylene oxide block copolymers; polyethylene glycol ethers of linear alcohols; reaction products of fatty acids with ethylene oxide and/or propylene oxide; polyvinyl alcohol; polyvinylpyrrolidone; copolymers of polyvinyl alcohol and polyvinylpyrrolidone; copolymers of (meth)acrylic acid and (meth)acrylic esters; and alkyl ethoxylates and alkylarylethoxylates.

In an embodiment, the method of the present invention may utilize the combination of a dithiocarbamate sprayed concurrently or subsequently with a Qo inhibitor fungicide and agriculturally acceptable diluent.

In an embodiment, the method of the present invention may utilize a composition comprising a dithiocarbamate and at least one Qo inhibitor fungicide and an oil based adjuvant.

Another aspect of the present invention, may be a method of treating white spot in maize in a host plant, wherein the treatment comprises treating the plant at the locus of the infection with a composition comprising a dithiocarbamate fungicide, and at least a Qo inhibitor fungicide.

In an embodiment, the present invention provides a method of treating white spot in maize in a host plant, wherein the treatment comprises treating the plant at the locus of the infection with a composition comprising a dithiocarbamate fungicide, at least a Qo inhibitor fungicide and an optional third fungicide selected from a systemic or contact fungicide.

In an embodiment, the present invention may provide a method of treating white spot in a host plant, wherein, the treatment comprises treating the plant at the locus of the infection with a composition comprising a dithiocarbamate fungicide selected from mancozeb, and at least a Qo inhibitor fungicide selected from azoxystrobin, trifloxystrobin, pyraclostrobin, picoxystrobin or mixtures thereof.

In an aspect, the present invention may provide a method of preventing white spot in host crops in the absence of pest pressure, in seasons when the crop is dormant or in debris of crops accumulated over the season by applying to such plants at the locus of possible infections a dithiocarbamate fungicide, and concurrently or subsequently to the dithiocarbamate fungicide, with at least a Qo inhibitor.

In an alternate embodiment, the present may provide a method of preventing white spot in host crops in the absence of pest pressure, in seasons when the crop is dormant in debris of crops accumulated over the season by applying to such plants at the locus of possible infections a Qo inhibitor fungicides, and concurrently or subsequently to the Qo inhibitor fungicide, with at least a dithiocarbamate fungicide.

It is readily understood that the method of treatment of the present invention may be used on all host plants that are infected by Phaeosphaeria mydis and/or Pantoea ananatis. Such exemplary host plants may include pineapple, sudangrass, Cantaloupe fruit, Honeydew melons, Onions, Eucalypts, Rice, Tomato, King oyster mushroom, watermelon etc.

As used herein, the term maize white spot, or simply white spot, is intended to mean the infection caused in plants, at least in part, due to Phaeosphaeria mydis and/or Pantoea ananatis. This infection occurs primarily in maize but may affect other susceptible crops too. The present description of this infection caused due to Phaeosphaeria mydis and/or Pantoea ananatis is not meant to be limited to its occurrence in maize, and is intended to include other crops too which are susceptible to this infection by P. annatis alone, P. maydis alone or a combination of both.

As the examples will demonstrate, the combination of a dithiocarbamate and a Qo inhibitor greatly improved the prevention and control of maize white spot in host plants, and surprisingly improved yields and resulted in greener, healthier plants and demonstrated excellent synergy in the control of white spot. The combination surprisingly improved disease control even in the more advanced stages of the disease.

### Examples

A study was conducted to determine the fungitoxicity of the contact fungicide such as a dithiocarbamate fungicide mancozeb and a Qo inhibitor fungicide such as azoxystrobin on the causal agent of white spot in maize (WSM) and compared to standard treatments of the combination of strobilurin and triazole fungicides [Quinone outside inhibitor (QoI)+demethylation inhibitor (DMI)]. Experiments were conducted in the field in various locations where fungitoxicity of dithiocarbamates and Qo inhibitor fungicides to white spot in maize was determined. A water dispersible formulation of 50 g of azoxystrobin mancozeb 700 g was prepared and several doses were tested (1.0, 1.5, 2.0 and 2.5 kg/ha in various application numbers). The effect of this treatment was compared to a commercial mixture containing 200 g of azoxystrobin+80 g of cyproconazole/L. All treatments carried, out had a standard dose of vegetable oil adjuvant added to each of the treatments. The tests were conducted on maize cultivar P3646H. The experiments were carried out using a randomised block design and four replications. The doses were as follows:

| Treatment | Dose P.C. (L, Kg/ha) |
|---|---|
| Treatment 1 (A) | 1.00 + 0.50 |
| Treatment 2 (B) | 1.50 + 0.50 |
| Treatment 3 (C) | 2.00 + 0.50 |
| Treatment 4 (D) | 2.50 + 0.50 |
| Commercial sample (Azoxystrobin + | 0.30 + 0.50 |
| Cyproconazole) + oil based adjuvant. (S) | |

The efficacy was calculated using Area under the Curve of Progress Disease (AAC PD) and the % Efficacy was calculated using

% E=(T−F/T)×100

Where: T=% of severity in the control, F=% of severity in the treatment with fungicide.

TABLE 1
Severity of white spot in maize with different treatments at 14 DAA
14 DAA

| | | AACPD | | | | | | |
|---|---|---|---|---|---|---|---|---|
| | Dose P.C. | | | | | Aver- | | Efic. |
| Treatment | (L, Kg/ha) | A | B | C | D | ages | p < 0.05′ | (%) |
| Control | — | 0.3 | 0.4 | 0.4 | 0.5 | 0.4 | b | 0.0 |
| A | 1.00 + 0.50 | 0.1 | 0.1 | 0.1 | 0.1 | 0.1 | a | 75.0 |
| | (adj) | | | | | | | |
| B | 1.50 + 0.50 | 0.1 | 0.1 | 0.1 | 0.1 | 0.1 | a | 81.3 |
| | (adj) | | | | | | | |
| C | 2.00 + 0.50 | 0.0 | 0.0 | 0.1 | 0.0 | 0.0 | a | 93.8 |
| | (adj) | | | | | | | |
| D | 2.50 + 0.50 | 0.0 | 0.0 | 0.0 | 0.0 | 0.0 | a | 100.0 |
| | (adj) | | | | | | | |
| S | 0.30 + 0.50 | 0.4 | 0.5 | 0.4 | 0.5 | 0.5 | b | 12.5 |
| | (adj) | | | | | | | |
| | CV (%) | | | | | | 28.25 | |

Table 1 demonstrates efficacy of treatments A, B, C, and D which were more efficacious as compared to commercial sample S. Sample D showed 100% efficacy as compared to 12.5% efficacy of the commercial sample.

TABLE 2
Severity of white spot in maize with different treatments at 28 DAA
28 DAA

| | | AACPD | | | | | | |
|---|---|---|---|---|---|---|---|---|
| | Dose P.C. | | | | | Aver- | | Efic. |
| Treatment | (L. Kg/ha) | A | B | C | D | ages | p < 0.05 ¹ | (%) |
| control | — | 5.0 | 4.6 | 5.0 | 4.6 | 4.8 | f | 0.0 |
| A | 1.00 + 0.50 | 2.3 | 1.9 | 2.0 | 1.8 | 2.0 | d | 58.3 |
| B | 1.50 + 0.50 | 1.5 | 1.4 | 1.5 | 1.4 | 1.5 | c | 69.8 |
| C | 2.00 + 0.50 | 1.0 | 0.8 | 0.8 | 1.0 | 0.9 | b | 81.3 |
| D | 2.50 + 0.50 | 0.2 | 0.2 | 0.2 | 0.1 | 0.2 | a | 96.4 |
| S | 0.30 + 0.50 | 4.5 | 4.2 | 4.3 | 4.0 | 4.3 | e | 11.5 |

| | |
|---|---|
| CV (%) | 5.39 |

It is clear from table 2 that test treatments A, B, C, and D demonstrate better efficacy as compared to markedly lower control demonstrated by the commercial sample S. The AAC PD figures clearly show greater disease progression and lower control in the commercial samples as compared to the treatments carried out using the method of the present invention.

TABLE 3
Severity of white spot in maize with different treatments at 35 DAA
35 DAA

| | | AACPD | | | | | | |
|---|---|---|---|---|---|---|---|---|
| | Dose P.C. | | | | | Aver- | | Efic. |
| Treatment | (L. Kg/ha) | A | B | C | D | ages | p < 0.05 ¹ | (%) |
| Control | — | 7.5 | 7.0 | 7.5 | 7.0 | 7.3 | e | 0.0 |
| A | 1.00 + 0.50 | 4.0 | 4.5 | 3.5 | 3.5 | 3.9 | c | 46.6 |
| B | 1.50 + 0.50 | 2.0 | 2.5 | 2.0 | 2.0 | 2.1 | b | 70.7 |
| C | 2.00 + 0.50 | 1.8 | 1.5 | 1.6 | 1.6 | 1.6 | b | 77.6 |
| D | 2.50 + 0.50 | 0.5 | 0.8 | 0.5 | 0.5 | 0.6 | a | 92.1 |
| S | 0.30 + 0.50 | 6.0 | 6.2 | 6.5 | 6.5 | 6.3 | d | 13.1 |

| | |
|---|---|
| CV (%) | 7.97 |

Table 3 demonstrates the efficacy of the test treatments A, B, C, and D as compared to the commercial sample S. The AACPD figures clearly show greater disease progression and lower control in the commercial samples as compared to the treatments carried out using the method of the present invention.

Tables 1, 2, and 3 therefore demonstrate the efficacy of treatments A, B, C and D in controlling white spot according to the method of the present invention. The treatments proved far more efficacious in the control of white spot as compared to the commercial treatment recommended for white spot.

It was thus found that the incorporation of a dithiocarbamate and Qo inhibitor increased the white spot control over the conventional strobilurin+conazole fungicide treatment standard. The combination of a dithiocarbamate and Qo inhibitor increased disease control and improved yield of plants. The instant invention is more specifically explained by above examples. However, it should be understood that the scope of the present invention is not limited by the examples in any manner. It will be appreciated by any person skilled in this art that the present invention includes aforesaid examples and further can be modified and altered within the technical scope of the present invention.

1. A method of treating white spot infection in a host plant, said method comprising treating the host plant at the locus of the infection with a dithiocarbamate fungicide, and prior to, concurrently or subsequently to treating with the dithiocarbamate fungicide, treating the host plant with a Qo inhibitor.

2. The method of in claim 1, wherein the dithiocarbamate fungicide is selected from maneb, metiram, mancozeb, zineb, ziram, thiram, propineb, and nabam.

3. The method of as claimed in claim 2, wherein the dithiocarbamate fungicide is mancozeb.

4. The method of in claim 1, wherein the Qo inhibitor fungicide is selected from fenamidone, famoxadone, azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin, and trifloxystrobin.

5. The method of in claim 4, wherein the Qo inhibitor fungicide is selected from azoxystrobin, pyraoxystrobin, pyraclostrobin, trifloxystrobin, and or a mixtures thereof.

6. A method of treating white spot infection in a host plant, said method comprising treating the host plant at the locus of the infection with a dithiocarbamate fungicide, a Qo inhibitor, and a third fungicide selected from a contact or a systemic fungicide.

7. The method of in claim 6, wherein the said contact fungicide is selected from copper fungicides, sulfur fungicides, phthalimide fungicides, chloronitrile fungicides, sulfamide fungicides, guanidine fungicides, triazines fungicides, and quinone fungicides.

8. The method of claim 6, wherein, the said systemic fungicide is selected from a demethylation inhibitor and a succinate dehydrogenase inhibitor.

9. A method of treating/controlling white spot infection comprising treating a host plant at the locus of the infection with a composition comprising a dithiocarbamate and a Qo inhibitor fungicide.

10. The method of in claim 9, wherein the dithiocarbamate is mancozeb.

11. The method of in claim 9, wherein, the Qo inhibitor is selected from azoxystrobin, picoxystrobin, pyraclostrobin, and trifloxystrobin.

12. The method of in claim 9, wherein the dithiocarbamate is mancozeb and the Qo inhibitor is azoxystrobin.

13. The method of in claim 9, wherein the composition is selected from a solution, an emulsion, a wettable powder, a water-based suspension, an oil-based suspension, a water-based suspension concentrate, an oil-based suspension concentrate, a powder, a dusting product, a paste, a soluble powder, a granule, a dispersible granule, a soluble granule, a granule for broadcasting, a suspension-emulsion concentrate, or an encapsulation.

14. A method of preventing white spot in maize infection in a host crop, comprising applying to the locus of possible infection a dithiocarbamate fungicide, and concurrently or subsequently to the dithiocarbamate fungicide, applying a Qo inhibitor, such that the application is carried out in the absence of pest pressure, in a seasons when the host crop is dormant or in debris of crops accumulated over the season.
